(19) United States
(12) Patent Application Publication
(10) Pub. No.: US 2023/0204394 A1
(43) Pub. Date: Jun. 29, 2023

(54) SENSOR MODULE AND RAIL VEHICLE COMPRISING SUCH A SENSOR MODULE

(71) Applicant: Siemens Mobility GmbH, München (DE)

(72) Inventors: Jürgen Francke, Berlin (DE); Jan Gräfing, Berlin (DE); Andreas Krutz, Berlin (DE); Thomas Waechter, Schönwalde-Glien OT Siedlung (DE)

(21) Appl. No.: 17/927,951

(22) PCT Filed: Apr. 16, 2021
(86) PCT No.: PCT/EP2021/059845

§ 371 Date: Nov. 28, 2022

(30) Foreign Application Priority Data
May 26, 2020 (DE) 10 2020 206 549.7

(51) Int. Cl. G01D 11/26; B61K 9/08

(52) U.S. Cl. CPC G01D 11/26; B61K 9/08

(57) ABSTRACT

A sensor module for a rail vehicle contains a box-like module housing with a housing wall having a front opening. It further has one or more environment sensors arranged in the module housing for acquiring environment data that can be perceived through the front opening. Moreover, it contains one or more front windows, which have in each case one window pane, which closes the front opening. As a result, the integration of environment sensors into rail vehicles, in particular for high-speed operation, can be optimized. A rail vehicle ideally contains such a sensor module.

Sensory environment detection to support the vehicle driver or for autonomous implementation of the driving task is essential for semi-automated and autonomous operation of rail vehicles. Environment sensors with different acquisition modes and ranges which can acquire the environment data in a section of the environment in their field of view are known for the vehicle-side detection of objects, obstacles or signals on the route of the rail vehicle and their position and/or state of motion relative to the rail vehicle. When a plurality of environment sensors are used, the environment data acquired thereby is merged to produce a high-quality environment image.

As the speeds at which rail vehicles are operated increase, so do the requirements for the integration of environment sensors into the rail vehicle in terms of the functionality of the sensors and also in terms of operator approval requirements, in particular at speeds of 200 km/h and above.

Therefore, the invention is based on the object of optimizing the integration of environment sensors into rail vehicles, in particular for high-speed operation.

One aspect of the object is achieved according to the invention by a sensor module for a rail vehicle with the features disclosed in claim 1. Accordingly, the sensor module comprises a box-like module housing with a housing wall having a front opening. It further comprises one or more environment sensors arranged in the module housing for acquiring environment data that can be perceived through the front opening. In addition, the sensor module comprises one or more front windows, each with a window pane, which close the front opening. The module housing closed by the housing wall and front windows protects environment sensors arranged therein during transport, installation and operation of the rail vehicle, in particular from the application of external mechanical forces. In the module housing, for example, different environment sensors can be fastened to special sensor mounts, which in turn can be detachably connected to the underside or rear of the housing wall via a uniform standard interface. Thus, the selection of sensor modules with a uniform module housing with different sensor configurations is easy and flexible. The front windows enable the environment sensors to acquire a section of the environment within their field of view and protect them from the outside. The size of the module housing is selected to be large enough to accommodate the required environment sensors, but small enough to minimize the space required and the cutout in the outer skin of the rail vehicle.

In one advantageous embodiment of the sensor module according to the invention, the one or more environment sensors are selected from the group consisting of laser scanners, lidar sensors, radar sensors, video cameras and the like. The combination of environment sensors with different acquisition modes and different ranges enables the acquisition of environment data of different types from a wide environment.

In a further advantageous embodiment of the sensor module according to the invention, the front window or front windows are embodied as part of an outer skin of the rail vehicle and continue the outer contour thereof aerodynamically. The front window or front windows can be embodied as flat, rounded or curved and set at an acute angle relative to the bottom of the housing wall, rearward in the direction of travel. A plurality of such front windows can be arranged lying in a common plane. However, they can also form an obtuse angle enclosing slight abutting edges with one another and with the outer skin of the rail vehicle adjoining the front windows. The front windows preferably form an aerodynamically favorable shape per se and with the adjoining outer skin that gives little cause for vortex shedding in the slipstream.

In a further advantageous embodiment of the sensor module according to the invention, the front window or front windows each have a window frame, which encloses the window pane and is detachably connected to the housing wall. This makes it possible to replace the front window or individual parts of a multi-part front window in the event of damage or for other reasons described below without having to replace the sensor module as a whole. This increases ease of maintenance and creates flexibility for different sensor configurations.

In a further advantageous embodiment of the sensor module according to the invention, the front window or front windows are selected from a front window set which has front windows with different window panes optimized for the transmission of the radiation used in each case by an environment sensor. If, for example, a video camera, a radar sensor and a lidar system are combined as environment sensors, all environment sensors use electromagnetic radiation, but with different wavelengths or wavelength ranges. Herein, the interaction between radiation and the windshield depends upon the wavelength of the radiation used and the windshield material used. Accordingly, a windshield optimized in terms of signal attenuation can be provided for each type of environment sensor. The front window set provided in this way enables the assembly of a sensor module optimized according to signal attenuation.

In a further advantageous embodiment of the sensor module according to the invention, the front window or front windows are selected from a front window set which has front windows with different window panes optimized for the aerodynamics of the respective outer contour of the rail vehicle. Such a front window set provides front windows with different shapes, which take into account the different outer contours of rail vehicles. For example, the outer contour of the rail vehicle can be embodied as flat or curved to a greater or lesser degree at the installation site, as required by the range of shapes on locomotive fronts and train noses. Front windows that are flat or curved to a greater or lesser degree can provide a front window set that continues the outer contour of the rail vehicle in a manner optimized in terms of flow dynamics when a sensor module according to the invention is installed.

In a further advantageous embodiment of the sensor module according to the invention, the module housing and the front windows are embodied in terms of strength and tightness for high-speed operation of the rail vehicle. The material and thickness of the housing wall and window panes and the connection techniques are selected to withstand the vibrations and impacts that occur during operation at 200 km/h or more. The connections between the front windows and the module housing and the bushings for power supply and signal lines in the housing wall are designed to be tight enough to ensure that moisture is unable to penetrate the module housing even during high-speed operation of the rail vehicle.

In a further advantageous embodiment of the sensor module according to the invention, the window panes have a water-and/or dirt-repellent coating on their outer sides. This prevents deposits of dirt particles, water droplets or other coatings on the windshields so that any resulting attenuation or falsification of the sensor signal is kept as low as possible. This ensures high availability of the sensor module according to the invention during operation of the rail vehicle.

One aspect of the object is achieved according to the invention by a rail vehicle with a sensor module as claimed in one of claims 1 to 8. Advantageously, the sensor module according to the invention can, for example, be integrated in trains or locomotives that travel at speeds of up to 200 km/h and more.

In one advantageous embodiment, a module holder is arranged in the nose region of the rail vehicle according to the invention behind an opening in its outer skin such that the sensor module can be guided through the opening in order to be received and detachably fastened in the module holder. The module holder can have a frame made of profile rails with side surfaces that can be open or closed by holder walls. The module holder forms a receptacle for a sensor module, which can be inserted into the receptacle from the outside through a, for example, rectangular cutout in the outer skin of the rail vehicle. When inserted, the sensor module is fastened in the module holder, wherein the front windows and adjoining outer skin form a smooth transition that is favorable in terms of flow dynamics.

Further properties and advantages will become apparent from the following description of an exemplary embodiment of the invention with reference to the drawings which schematically illustrate:

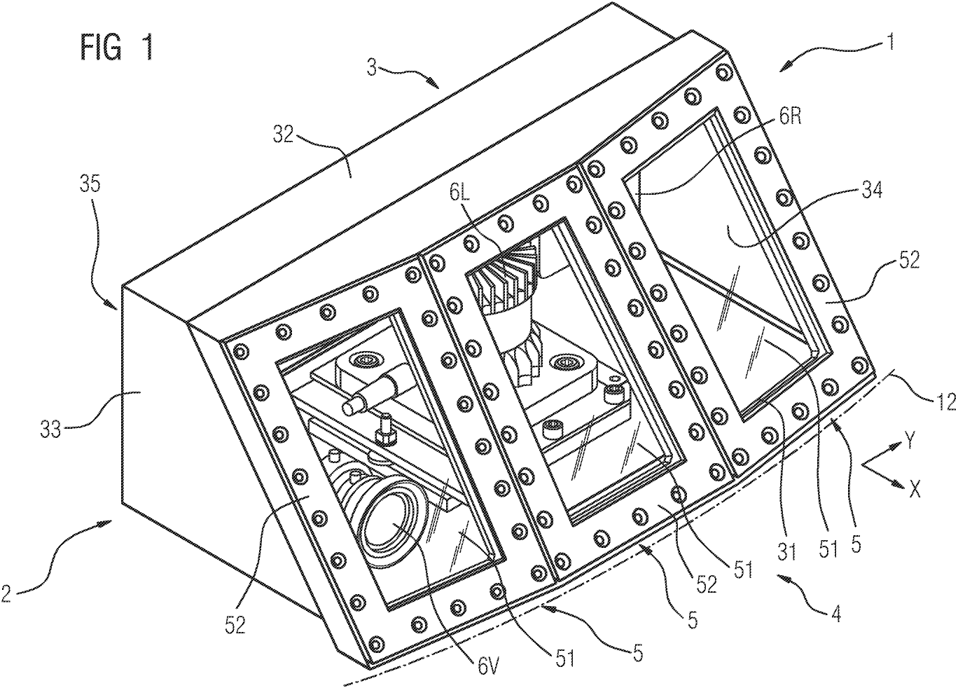

FIG. 1 a perspective view of a sensor module according to the invention and

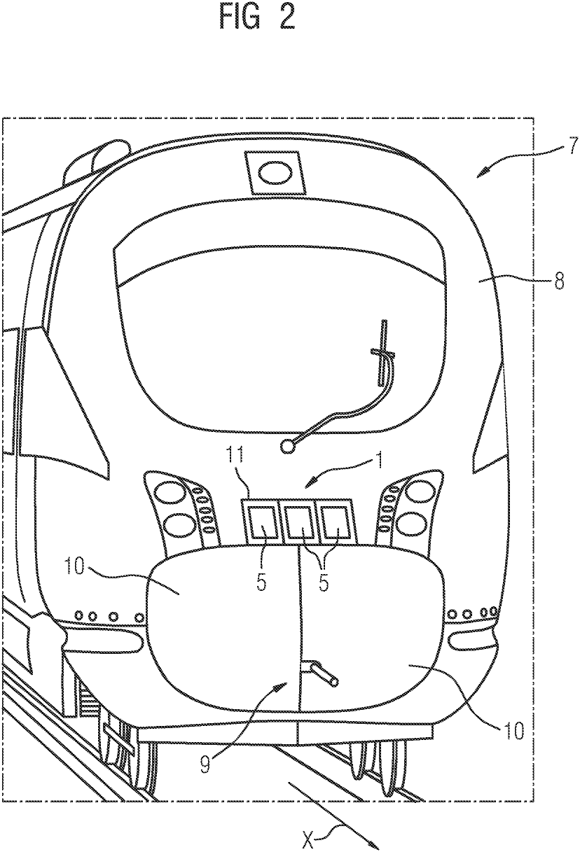

FIG. 2 a rail vehicle comprising a sensor module according to FIG. 1 integrated in the nose region.

According to FIG. 1, a sensor module 1 according to the invention comprises a box-like module housing 2 the housing wall 3 of which has a rectangular bottom part 31, a rectangular top part 32 which is narrower in comparison, two trapezoidal side parts 33 and 34, and a rectangular back part 35. A rectangular front opening 4 in the housing wall 3 is closed by three front windows 5. Environment sensors – designated 6 in their entirety – embodied to acquire environment data from an environment section that can be perceived through the front opening 4 are arranged within the module housing 2. In the exemplary embodiment depicted, a video camera 6V, a lidar system 6L and a radar sensor 6R are arranged as environment sensors 6 looking from left to right against the direction of travel X of the rail vehicle 7 (see FIG. 2). The module housing 2 has a size such that other environment sensors 6, for example an infrared camera or a laser scanner, can also be arranged therein, depending upon what type of environment data is to be acquired. Environment sensors 6 with different acquisition modes and different ranges enable the acquisition of environment data of a different type from a wide environment, for example environment image data including distance and position data of objects and obstacles. The module housing 2 closed by the housing wall 3 and the front windows 5 protects the environment sensors 6 arranged therein during transport, installation and operation of the rail vehicle 7, in particular from the application of external mechanical forces.

According to FIG. 2, the sensor module 1 according to the invention 1 is integrated in the middle of the side in the nose region of a rail vehicle 7 embodied as a high-speed train. A head part 8 of the rail vehicle 7 tapers in a streamlined manner to the nose of the train 9 where a two-part nose flap 10 covers a coupling that is not visible in FIG. 2. The outer skin of the head part 8 has a rectangular cutout 11 above the nose flap 10 behind which a module holder, not shown, is arranged in the interior of the head part 8. The sensor module 1 can be inserted into the module holder from the outside and extracted again for removal through the cutout 11. The sensor module 1 received by the module holder is fastened detachably there. The module holder can be embodied as a box-shaped shaft corresponding to the module housing 2. The front windows 5 continue the outer contour of the outer skin in the region of the cutout 11 aerodynamically and thus form part of the outer skin by forming a smooth transition that is favorable in terms of flow dynamics. In the exemplary embodiment depicted, the front windows 5 are embodied as flat and set at an acute angle relative to the bottom part 31 of the housing wall toward the rear in the direction of travel X. In order to reproduce the round contour 12 in the transverse direction Y, the two outer front windows 5 form an obtuse angle relative to the central front windows 5.

Each of the front windows 5 has a window frame 52, which encloses a window pane 51 and is detachably connected to the housing wall 3. This makes it possible to replace individual front windows 5 in a simple manner. For example, front windows 5 with different window panes 51 optimized for transmission of the radiation used in each case by an environment sensor 6 can be used in order to keep signal attenuation low when light or radio waves pass through. Similarly, it is possible for front windows 5 with different window panes 51 adapted to the respective outer contour of the rail vehicle 7 to be used in order to optimize the aerodynamics of the rail vehicle 7. In order to prevent deposits of dirt particles, water droplets or other coatings on the windshields 51, their outer sides can have a water and/or dirt-repellent coating.

The module housing 2 closed by the front windows 5 meets railroad-specific requirements in terms of strength and tightness for high-speed operation and facilitates the function of the environmental sensors 6. The construction effort for the sensor module 1 according to the invention is incurred once and can then be integrated into a number of rail vehicles 7 in a variety of ways and can accommodate different environment sensors 6 in different configurations depending on the requirements. The design with the module housing 2 and module holder enables the rail vehicle 7 to be modified by the operator, while the sensor module 1 must be self-contained and not belong to the vehicle operator. The sensor module 1 is constructed in such a way that it satisfies current railroad standards. The cabling and all parts belonging to the driver assistance system also conform to railroad standards. The installation of the sensor module 1 does not restrict the performance data of the rail vehicle 7, in particular with regard to the design-related maximum speed.

1-10. (canceled)

11. A sensor module for a rail vehicle, comprising:
a box-shaped module housing with a housing wall having a front opening formed therein;
at least one sensor disposed in said box-shaped module housing for acquiring environment data being perceived through said front opening; and
at least one front window, each with a window pane, which closes said front opening.

12. The sensor module according to claim 11, wherein said at least the one sensor is selected from the group consisting of video cameras, lidar systems, and radar sensors.

13. The sensor module according claim 11, wherein said at least one front window is embodied as part of an outer skin of the rail vehicle and continues an outer contour thereof aerodynamically.

14. The sensor module according to claim 11, wherein said at least one front window each have a window frame, which encloses said window pane and is detachably connected to said housing wall.

15. The sensor module according to claim 14, wherein said at least one front window is selected from a front window set which has front windows with different window panes optimized for a transmission of radiation used in each case by said at least one sensor.

16. The sensor module according to claim 14, wherein said at least one front window is selected from a front window set which has front windows with different window panes optimized for aerodynamics of a respective outer contour of the rail vehicle.

17. The sensor module according to claim 11, wherein:
said at least one front window is one of a plurality of front windows; and
said box-shaped module housing and said front windows are embodied in terms of strength and tightness for high-speed operation of the rail vehicle.

18. The sensor module according to claim 11, wherein said window pane has a water-repellent and/or dirt-repellent coating on its outer side.

19. A rail vehicle, comprising:
said sensor module according to claim 11.

20. The rail vehicle according to claim 19, further comprising:
a nose region having an outer skin with a cutout formed therein; and
a module holder disposed in said nose region of the rail vehicle behind sad cutout in said outer skin of the rail vehicle such that said sensor module being guided through said cutout is received and detachably fastened in said module holder.
